(19) United States
(12) Patent Application Publication
(10) Pub. No.: US 2012/0259574 A1
(43) Pub. Date: Oct. 11, 2012

(54) DESIGNED-BASED YIELD MANAGEMENT SYSTEM

(76) Inventors: Chenmin Hu, Santa Clara, CA (US); Bo Su, San Jose, CA (US); Ping Zhang, Saratoga, CA (US); Yuan Xu, Sunnyvale, CA (US); Qing Zhang, Shanghai (CN)

(21) Appl. No.: 13/080,474

(22) Filed: Apr. 5, 2011

(51) Int. Cl. G06F 19/00

(52) U.S. Cl. 702/117

(57) ABSTRACT

An integrated-circuit yield improvement system includes a global signature analysis/grouping module configured to receive an integrated circuit (IC) design and identify areas in the IC design that include potential defect signatures based on the defect signatures stored in the defect signature library. The global signature analysis/grouping module can produce a global signature map indicating these areas and their associated potential defect signatures in the IC design. A local signature analysis/grouping module can identify and group local defect signatures in the IC design with the process monitoring and yield data as input, to output grouped local signatures. An intelligent learning engine can analyze the global signature map and the grouped local signatures and update some of the defect signatures in the defect signature library. A feedback loop is formed to update and renew the contents of the defect signature library for each new IC design while process and yield are improved.

### BACKGROUND OF THE INVENTION

The present disclosure relates to detecting defects in semiconductor products and, more particularly, to classifying and grouping systematic and random defects based on design circuitry knowledge and inline IC manufacturing process and yield monitoring data.

Semiconductor-based integrated circuits (ICs) are typically designed based on repetitive structures such as individual logic cells or larger blocks that perform specific electrical functions. In some cases, these repetitive structures may exhibit specific failure modes due to an interaction of the layout with a specific process module used in the manufacturing flow. Systematic defects can arise from a variety of causes, which may include imperfections in the deposition, patterning or removal of a specific material or structure. Defects may also be caused by shifting process parameters, such as deposition, lithographic, and etching.

Some defects also arise due to design-process interactions (DPI defects), that is, the sensitivity of particular designs to process variations, such as variations in deposition, lithographic, etch, or other parameters. Fabrication of integrated circuits typically includes a series of multiple photolithography and etch operations on a semiconductor substrate, each of which transfers a circuit layout through a photo-mask to a silicon wafer. A photolithography process begins by applying a thin layer of a photo-resist material to the substrate surface of a silicon wafer. The photo-resist is then exposed through a photolithography exposure tool called stepper or scanner to a radiation source with wavelength in deep ultra-violet (DUV) range that changes the solubility of the photo-resist at areas exposed to the radiation. The photo mask, which contains circuit layout information, consists of a patterned material or materials that interact with the exposing radiation through intensity and/or phase modulation. Such image transferring from a circuit design layout to a silicon wafer can be also accomplished in non-optical lithography process like electron beam direct writing. The invention disclosed applies to all lithographic processes.

To improve an integrated circuit functionality and performance, IC manufacturers normally shrink the circuit components and at the same time, increases the number of circuit components. It becomes necessary to reduce the size of the features, i.e., the lines and spaces that make up the circuit elements on the semiconductor substrate. The minimum feature size that can be accurately produced on a substrate is limited by the ability of the fabrication process to form an undistorted optical image of the mask pattern onto the substrate, by the chemical and physical interaction of the photo-resist with the developer, and by the uniformity of the subsequent process (e.g., etching or diffusion) that uses the patterned photo-resist.

When a photolithography system attempts to print circuit elements having sizes well below the wavelength of the exposing radiation, the resulting shapes of the printed circuit elements become significantly different from the corresponding pattern on the mask. For example, line widths of circuit elements may vary depending on the proximity of other lines. The inconsistent line widths can then cause circuit components that should be identical to operate at different speeds, thereby creating problems with the overall operation of the integrated circuit. As another example, line ends tend to shorten or “pull back.” The small amount of shortening becomes more significant as the lines themselves are made smaller. Furthermore, pulling back of the line ends can cause connections to be missed or to be weakened and prone to failure.

As electronic devices become more miniaturized and more powerful, IC devices become smaller and more devices are packed in each chip. The cost of manufacturing has increased and the yield is decreased and the new causes of yield decrease emerge as new materials used and shrinking process variation tolerances. Unless measures are taken to reduce variations in manufacturing processes the number of defects will typically increase in inverse proportion to feature size. Another approach, referred to as design for manufacturability (DFM), is to generate designs that are less sensitive to anticipated process variations, thereby reducing the number DPI defects and improving product yield.

Inspection tools are frequently utilized during mass production, where efforts are focused on random defects and process monitoring, in an effort to assure that the process does not drift. For example, an inspection tool can utilize multi-beam DUV laser illumination and highly sensitive photo-detectors to generate defect and reference images allowing a wide variety of defects to be detected. Such inspection tools typically generate defect maps identifying possibly thousands to tens of thousands of defects at various locations in a semiconductor wafer surface.

The sheer volume of these defects makes it challenging to extract meaningful data regarding DPI defects. The individual defects typically identify locations where a critical dimension has deviated beyond an acceptable tolerance (possibly leading to electrical shorts, voids or breaks). As such, substantial and time consuming analysis and parsing of the individual defects would be required in order to identify design-process interaction and identify required changes in design or process. Further, many of the defects are repetitive due to the repetitive nature of the majority of device layouts. In other words, similar defect mechanisms will typically trigger multiple defects on various locations across the die. However, manually inspecting defect maps and design layout in an effort to correlate these repetitive defects into their unique defect mechanisms is time and cost prohibitive.

Simulations may be performed to identify potential failure locations (“hot-spots”) across the die, for example, in an effort to focus defect inspection on a limited number of locations and, therefore, reduce the time and cost for meaningful analysis. Unfortunately, not all of these identified hot-spots actually result in defects. Conversely, not all of the actual defects are predicted by the modeling simulation.

Accordingly, there is a need for improved techniques for identifying and classifying defects in semiconductor-based integrated circuit, and for improving designs as well as process parameters wafers to eliminate the defects.

### SUMMARY OF THE INVENTION

In a general aspect, the present invention relates to an integrated-circuit yield improvement system that includes a defect signature library that stores defect signatures and one or more computer processors. The one or more computer processors include a global signature analysis/grouping module configured to receive an integrated circuit (IC) design and identify areas in the IC design that include potential defect signatures based on the defect signatures stored in the defect signature library, wherein the global signature analysis/grouping module is configured to produce a global signature map indicating these areas and their associated potential defect signatures in the IC design; a local signature analysis/grouping module configured to receive the IC design and process monitoring and yield data related to the IC design, wherein the local signature analysis and grouping module is configured to identify and group local defect signatures in the IC design and the process monitoring and yield data to output grouped local signatures; and an intelligent learning engine configured to analyze the global signature map and the grouped local signatures for each location, and to store, in the defect signature library, some of the defect signatures in the global signature map and the grouped local signatures, wherein the integrated-circuit yield improvement system is configured to output parameters for setting IC manufacturing process based on the global signature map and the grouped local signatures.

Implementations of the system may include one or more of the following. The IC yield improvement system can further include a filter and risk ranking module configured to identify killer defect signatures and filter out nuisance defects from the grouped local signatures and configured to output defects of interest comprising the killer defects. The intelligent learning module can produce rules for filtering defect signatures, wherein the filter and risk ranking module configured to filter out defects from the grouped local signatures based on the rules. The IC yield improvement system can further include a comparison and classification module configured to compare the defect of interests with the defect signatures in the defect signature library and to group defects of interests that have matched counterparts in the defect signature library, wherein the parameters for setting IC manufacturing process include the group defect of interests that have matched counterparts in the defect signature library. The comparison and classification module can include: a signature search module configured to search the global signature map and the DOI for defect signatures as represented in the defects of interests; a defect signature comparison engine configured to compare the defect signatures similar to DOI found in the search in the global signature map with the defect signatures stored in the defect signature library; and a signature grouping classification module configured to group defects of interests that have matched counterparts in the defect signature library. The intelligent learning engine can store the manufacturing process setting parameters and to send the manufacturing process setting parameters as feedback to the global signature analysis grouping module, wherein the global signature analysis/grouping module is configured to identify areas in the IC design that include potential defect signatures using the manufacturing process setting parameters. The global signature analysis/grouping module can include: a partition and signature selection module configured to partition the IC design into functional blocks and to select a portion or all the IC design as defined by a user; a global signature analysis module configured to detect potential defect signatures in the whole IC design based on the defect signatures stored in the defect signature library and to identify their respective positions in the IC design; and a signature grouping module configured to group the defect signatures obtained by the global signature analysis module to produce the global signature map. The local signature analysis/grouping module can include: a defect pattern selection configured to allow a user to select a local patterns in the IC design and the process and yield monitoring data; a local signature analysis and sorting module configured to detect defect signatures in local areas of the IC design with the assistance of the defect signature library; and a signature grouping module configured to separate the defect signatures in local areas obtained by the local signature analysis and sorting module into different groups to output the grouped local signatures.

In another general aspect, the present invention relates to an integrated-circuit yield improvement system that includes a defect signature library that stores defect signatures; and one or more computer processors. The one or more computer processors include a global signature analysis/grouping module configured to receive an integrated circuit (IC) design and identify areas in the IC design that include potential defect signatures based on the defect signatures stored in the defect signature library, wherein the global signature analysis/grouping module is configured to produce a global signature map indicating these areas and their associated potential defect signatures in the IC design; a local signature analysis/grouping module configured to receive the IC design and process monitoring and yield data related to the IC design, wherein the local signature analysis and grouping module is configured to identify and group local defect signatures in the IC design and the process monitoring and yield data to output grouped local signatures; a filter and risk ranking module configured to identify killer defect signatures and filter out nuisance defects from the grouped local signatures and configured to output defects of interest comprising the killer defects; and an intelligent learning engine configured to analyze the global signature map and the grouped local signatures for each location, and to store, in the defect signature library, some of the defect signatures in the global signature map and the grouped local signatures, wherein the integrated-circuit yield improvement system is configured to output parameters for setting IC manufacturing process based on the global signature map and the grouped local signatures, wherein the intelligent learning module is configured to produce rules for filtering defect signatures, wherein the filter and risk ranking module configured to filter out defects from the grouped local signatures based on the rules.

In yet another general aspect, the present invention relates to a computer-implemented method for improving manufacturing yield in an integrated circuit. The method includes receiving an integrated circuit (IC) design in one or more computer processors that include a global signature analysis/grouping module, a local signature analysis/grouping module, and an intelligent learning engine, wherein the one or more computer processors are in communication with a defect signature library; identifying, by a global signature analysis/grouping module, areas in the IC design that include potential defect signatures based on the defect signatures stored in the defect signature library; producing, by the global signature analysis/grouping module, a global signature map indicating these areas and their associated potential defect signatures in the IC design; identifying and grouping, by the local signature analysis and grouping module, local defect signatures in the IC design and the process monitoring and yield data to output grouped local signatures; analyzing the global signature map and the grouped local signatures for each location by the intelligent learning engine; storing, in the defect signature library, by the an intelligent learning engine, some of the defect signatures in the global signature map and the grouped local signatures; and outputting parameters for setting IC manufacturing process based on the global signature map and the grouped local signatures.

Embodiments may include one or more of the following advantages. The disclosed system and methods can detect defects in the design of integrated circuit with improved accuracy and higher sensitivity compared to conventional techniques. The disclosed system and methods can also more accurately separate killer defects from nuisance defects in the integrated circuit designs, which becomes increasingly important because different types of defects increase rapidly as the minimum IC gate sizes are pushed below 45 nm. The intelligent learning module in the disclosed system can effectively cross learn knowledge accumulated in the pre-stored defect patterns, defect signature analysis and grouping of the current IC design, filtering and risk ranking of the defects, and comparison and classification of the defects. The knowledge gain can be dynamically used to improve all aspects of the defect management within the same design process.

The disclosed system and methods can also accumulate defect and yield learning and use the learning later in defect analysis and classification. It can provide design-based, systematically analysis fast and shorten the time from data to information. It can pin-point the sensitive monitoring regions/patterns to shorten the potential inspection time by smart sampling. It has the capability to separate the systematic defects and random defects and to avoid the complications associated with the mixing the systematic defects and random defects, and provide the guide to treat them differently.

Although the invention has been particularly shown and described with reference to multiple embodiments, it will be understood by persons skilled in the relevant art that various changes in form and details can be made therein without departing from the spirit and scope of the invention.

### BRIEF DESCRIPTION OF THE DRAWINGS

The following drawings, which are incorporated in and form a part of the specification, illustrate embodiments of the present invention and, together with the description, serve to explain the principles of the invention.

FIG. 1 is a system diagram for an intelligent IC yield improvement system in accordance with the present invention.

FIG. 2 is a detailed system diagram for intelligent IC design optimization and yield management in accordance with the present invention.

FIG. 3A illustrate exemplified functions of signature analysis and grouping for a global IC circuit design in accordance with the present invention.

FIG. 3B is an exemplified flow diagram for involving signature analysis of a global IC circuit design performed by the intelligent IC design optimization and yield management in accordance with the present invention.

FIG. 4A illustrate exemplified functions of local signature analysis and grouping for an IC circuit design in accordance with the present invention.

FIG. 4B is an exemplified flow diagram for involving local signature analysis of an IC circuit design performed by the intelligent IC design optimization and yield management in accordance with the present invention.

FIG. 5 illustrates exemplified functions of filter and risk ranking of defects in an IC design in accordance with the present invention.

FIG. 6 illustrates exemplified functions of defect search, comparison and classification in an IC design in accordance with the present invention.

### DETAILED DESCRIPTION OF THE INVENTION

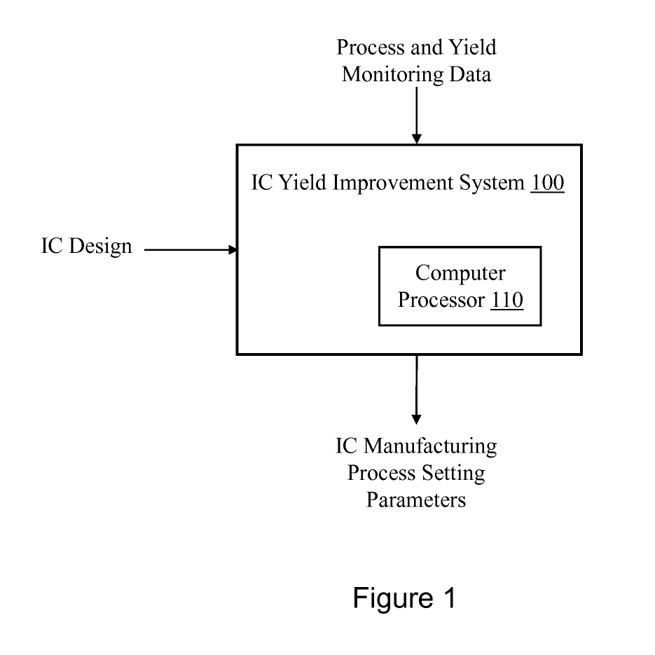

Referring to FIG. 1, an intelligent IC yield improvement system 100 receives inspection data and inline process monitoring and yield data and an IC design. Inspection data can include several optical scanning defect data in standard ASCII format, with defect locations, optically detected defect sizes, and other defect information. Process monitoring and yield data contains inline metrology data (e.g., circuit line width or space between lines, via/contact size, etc. and overlay measurement data), failure analysis data, and electrical test data. Process monitoring and yield data can include information about global chip-wide or region-wide defect signatures, or local defect signatures.

As discussed in more detail below, the intelligent IC yield improvement system 100 can identify, analyze, group, filter, select, and classify defect signatures with the assistance of an intelligence learning engine and a defect signature library. The intelligent IC yield improvement system 100 can output process setting parameters to improve yield for manufacturing the integrated circuit. Process and yield monitoring data include inspection data, metrology data, failure analysis data, and electrical test data obtained during IC manufacturing of a given IC design, which can include defect signatures obtained by various measurements. The process setting parameters can define the inclusion or the exclusion of certain processing steps in IC manufacturing, and include settings of IC manufacturing equipment, decision on whether and how to generate test chip, and recipes for controlling metrology and inspection equipment. Recipes are used by most inspection and metrology equipments in micro-fabrication to control the positions and the parameters of measurements and inspections.

The intelligent IC yield improvement system 100 includes one or more computer processors 110 for performing various computational tasks as elaborated below, and other necessary computer components such as a display device, a memory device, communication devices, and output/input devices.

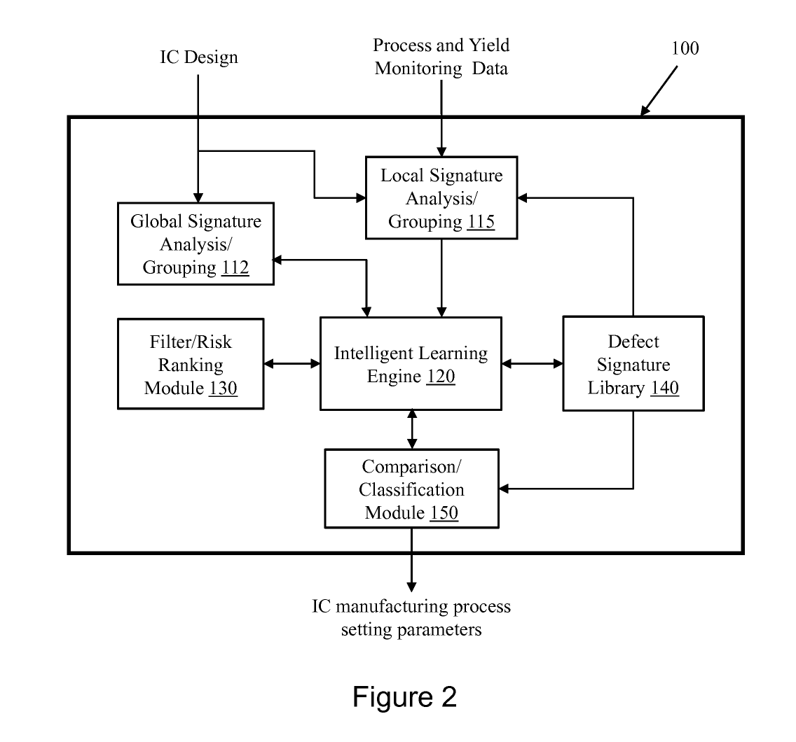

Referring to FIG. 2, the intelligent IC yield improvement system 100 includes a global signature analysis and grouping module 112 and a local signature analysis and grouping module 115, an intelligent learning engine 120, a filter and risk ranking module 130, a defect signature library 140, and a comparison classification module 150.

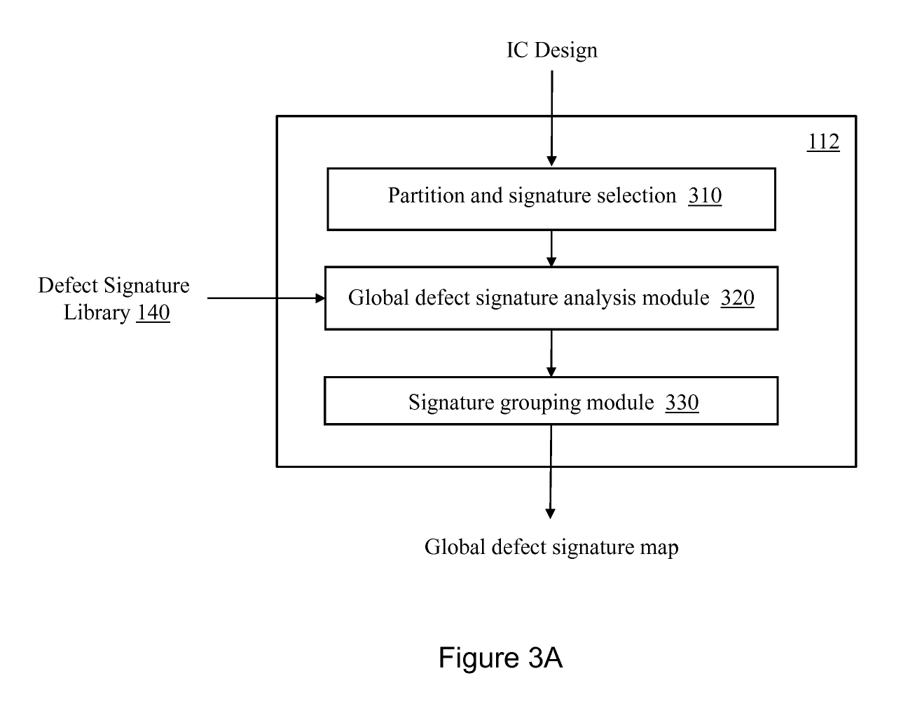

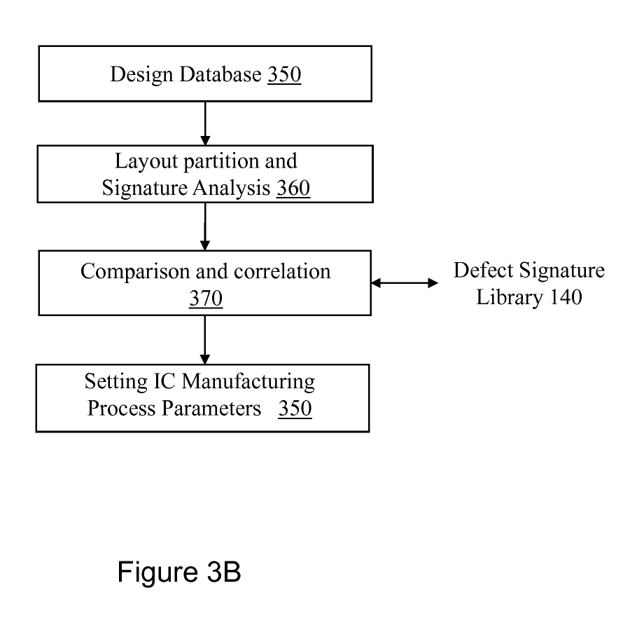

Referring FIGS. 3A and 3B, the IC design is received from a design database by the global signature analysis and grouping module 112 (step 350). The IC design is analyzed by the global signature analysis and grouping module 112 with the assistance of the defect signature library. The global signature analysis and grouping module 112 includes a partition and signature selection module 310 that partitions the IC design into functional blocks in pre-defined size patterns (step 360). The partition and signature selection module 310 select a portion or all of the IC design as defined by the user. The operations of the global signature analysis and grouping module 112 are performed before or at the early stage of wafer manufacturing of an IC design.

The global signature analysis and grouping module 112 also includes a global signature analysis module 320 and a signature grouping module 330. The global signature analysis module 320 can detect potential defect signatures in the whole IC design (i.e. chip wide) and identify their positions in the IC design, by performing one or more of the following tasks (step 360): identifying patterns and calculating vertex density, computing polygon sizes and counting the number of polygons for potential defect signatures, single via/contact, minimal features such as a line width or a space between lines, line ends, electrical connectivity, and other user defined signature analysis. Vertex density reflects the complexity of patterns, which has direct influence on chemical and mechanical polishing. Single vias or contacts, if failed, are killer defects. On the other hand, redundant vias allow the IC to continue to work even one via fails. The global signature analysis 320 can also detect transistors and gates, gate pattern structures, gate width and lengths.

The signature grouping module 330 can group the potential defect signatures obtained by the global signature analysis module 320, which place the same or similar patterns or patterns with the same signatures into the same group. The grouped potential defect signatures are output as a chip-wide global signature map that indicates these areas and their associated potential defect signatures in the IC design.

In one aspect, the intelligent learning engine 120 performs central control: it receives and stores the global chip signature map produced by the global signature analysis and grouping module 112, and distributes it to the filter/risk rank module 130, the defect signature library 140, and the comparison classification module 150. The filter/risk rank module 130 analyzes regions of the IC circuit design and mark the regions the IC circuit design with different levels of risks for defects. Some regions of the IC design are determined to have no risk and are filtered out. The regions with the same type of defect signatures are grouped together.

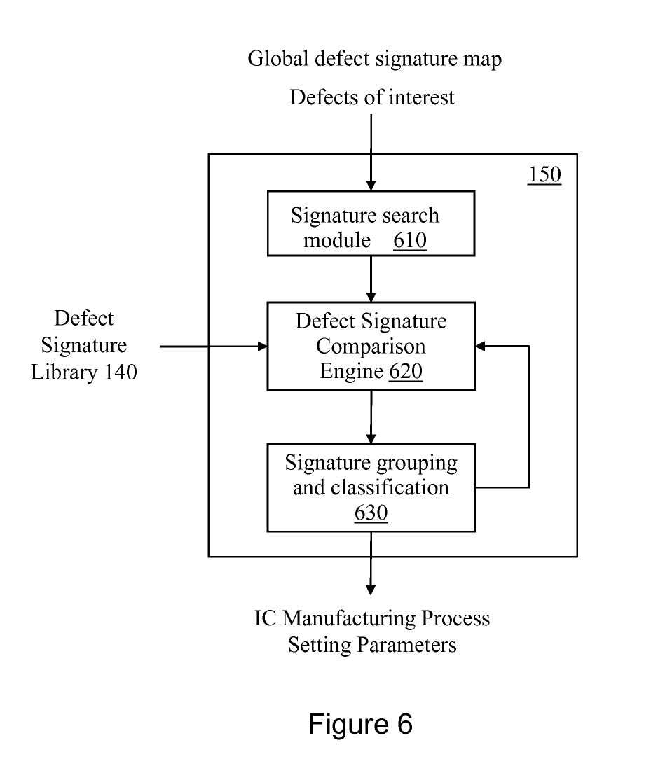

The comparison classification module 150, as discussed in relation to FIG. 6 below, can compare and correlate the potential defect signatures in the global chip signature map with those stored in the defect signature library 140 (step 370). If no match of a potential defect signature is found in the defect signature library 140, the potential defect signature is added to the defect signature library 140 (step 380). If all the potential defect signatures have matches in the defect signature library 140, the defect signatures are output by the comparison classification module 150 for setting process parameters for IC manufacturing (step 390).

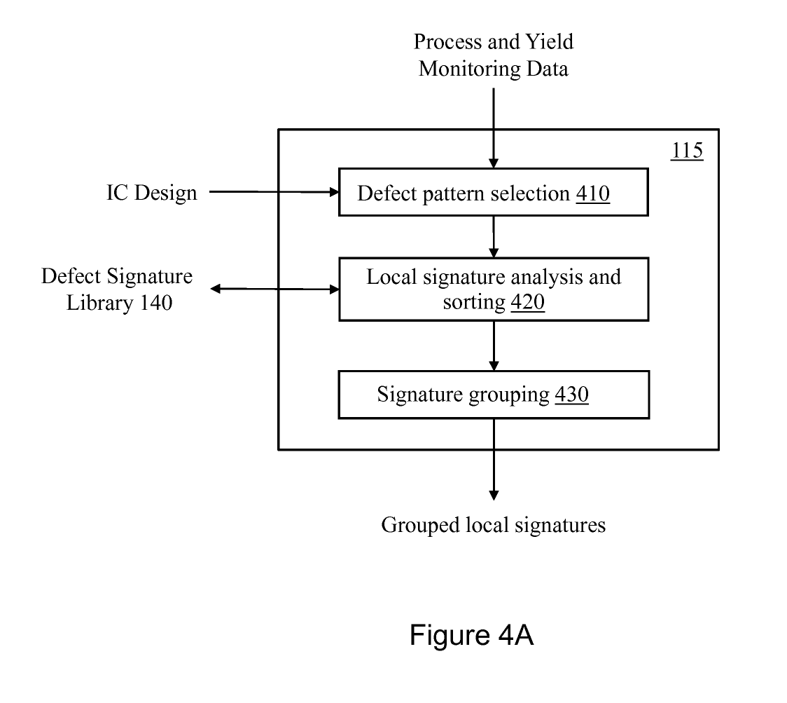

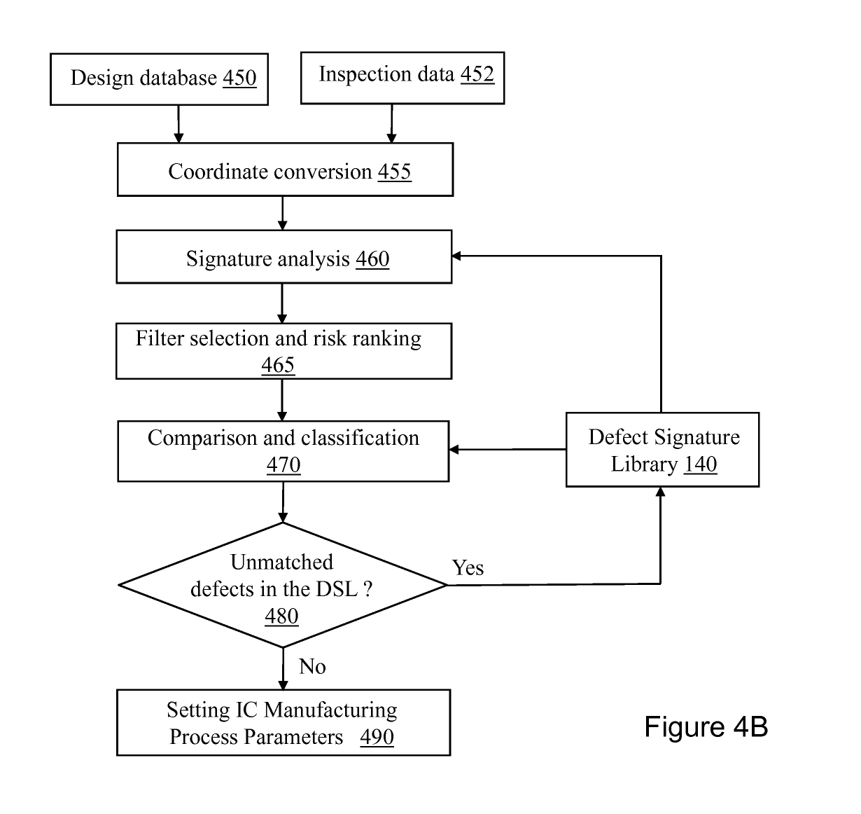

The operations of the local signature analysis and grouping module 115 are performed during or after wafer manufacturing of an IC design. Referring FIGS. 2, 4A and 4B, the local signature analysis and grouping module 115 includes a defect pattern selection module 410 that receives the IC design (step 450) and the process and yield monitoring data as input (step 452). The coordinates of the defects in the process and yield monitoring data are converted into the coordinates of the design layout (step 455). The defect pattern selection 410 allows a user to select, in the common design layout coordinate, local patterns and define pattern size for each defect based on each defect location in inspection data. The IC design is analyzed by a local signature analysis and sorting module 420 (step 460) with the assistance of the process and yield monitoring data and the defect signature library. The local signature analysis and sorting module 420 can detect potential defect signatures in local areas of the IC design by performing one or more of the following tasks: determine local critical area analysis (CAA), calculate pattern or vertex density, calculate polygon size of the patterns, check electrical connectivity, contact/via counts inside, line ends and minimal features (space and width), and user defined defect signatures using the process and yield monitoring data as input. CAA is a direct measure of potential defect's electrical impact to its surrounding circuit. Based on defect size and its possibility to open or short electrical wires, local CAA is a measure of probability of the defect becomes a killer. Local CAA can be conducted in local areas around a detected defect including open and short circuit. The local area is a square defined as a defect location with measurement uncertainty. Local CAA can be reported as a ratio of the area of the defect causes open and short over the total selected local area: CAA=0 corresponds to a defect will not cause a open or a short; while CAA=1 corresponds to the defect will cause a open or a short—a killer defect.

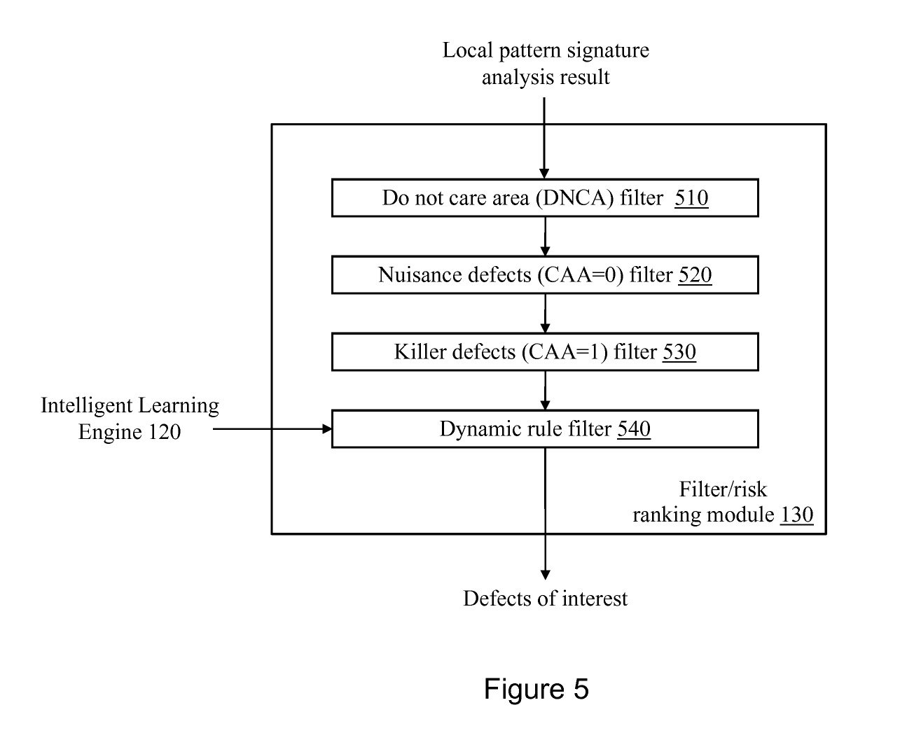

A signature grouping module 430 can separate the potential local defect signatures obtained by the local signature analysis and sorting module 420 into different groups. The same or similar local patterns or local patterns with the same signatures are placed in the same group. The grouped local defect signatures are output to the intelligent learning engine 120 and then to the filter and risk ranking module 130 (FIG. 2). The filter and risk ranking module 130 (step 470), referring to FIG. 5, includes a “do not care area” (DNCA) filter 510, a nuisance defects (CAA=0) filter 520, a killer defects (CAA=1) filter 530, a dynamic rule filter 540, and outputs defects of interest the comparison classification module 150. The rules can include large and dummy area (DNCA), pattern or vertex density, local CAA, contact/via counts inside, and line ends and minimal features (space and width). Defects located in empty area or in dummy fill area have no impact on circuit at all and called “do not care” defect. The filter 510 finds those “do not care” defects and filter them out from the list of potential defect signatures. A potential defect is small, and located in a large space, or in a large feature is most likely a nuisance defect (CAA=0), which is filtered out by the filter 520. The defect with CAA=1 can cause circuit open or short and are thus killer defects, which are kept by the killer defects filter 530. The remaining defects can be analyzed by analytical and empirical rules to gauge their potential impacts on the IC circuit. The rules can include any parts or full listed: local CAA value, minimal width/space counts, small line end counts, gate counts, contact/via counts, connection with upper or lower layers.

In some embodiments, new rules can be developed by the intelligent learning module 120 to be applied by the dynamic rule filter 540. For an IC design, the IC manufacturing processes normally go through development, pilot, and volume production stages, through which the yield is increased. The rules are developed in the development stage and pilot stage, when the yield is low and defect level is high. In volume product phase, rules are usually fixed. When good correlation is obtained between a defect signature and one in the defect signature library, some rules can be fixed while other rules continue to be optimized by the intelligent learning module 120. The dynamic rule filter 540 can filter defect signatures based on the rules produced by the intelligent learning module 120. In that process, the intelligent learning module 120 also updates new signatures to the defect signature library 140. Thus the intelligent learning module 120 helps to form a feedback loop for updating and renewing the contents of the defect signature library 140 for each new IC design while process setting parameters and yield are improved. As a result, the filter and risk ranking module 130 outputs defects of interest (DOI) to the intelligent learning module 120.

The intelligent learning module 120 receives defect signatures from the filter and risk ranking module 130 and compare to those in the defect signature library 140. If new group of defect signatures appear, the intelligent learning module 120 updates the defect signature library 140. If an existing group defect signatures appears, the intelligent learning module 120 treats it using the past experience without adding to the defect signature library 140.

The comparison classification module 150 can compare the potential defect signatures with the local defect signatures with those stored in the defect signature library 140 (step 470). If no match of a potential defect signature is found in the defect signature library 140, the potential defect signature is added to the defect signature library 140 (step 480). If all the potential defect signatures have matches in the defect signature library 140, the defect signatures are output by the comparison classification module 150 for setting process parameters for IC manufacturing (step 490).

Referring to FIG. 6, the comparison classification module 150 receives the global chip signature map as a result of the global signature analysis and grouping module 112 the defects of interest from the local defect signature analysis and grouping module 115, as described above. The comparison classification module 150 includes a signature search module 610, a defect signature comparison engine 620 in communication with the defect signature library 140, and a signature grouping classification module 630. The signature search module 610 searches the chip-wide global signature map and the DOI for defect signatures as represented in DOI. The areas contain DOI and DOI signatures should be monitored in IC process. The defect signature comparison engine 620 compare the defect signatures similar to DOI found in the search in the global signature map with the defect signatures stored in the defect signature library 140. The comparison function of the defect signature comparison engine 620 can include one or more of the following steps: exact pattern matching, similar pattern matching, center exact and periphery similar pattern matching, pattern signature matching, multi level matching and grouping, and user defined pattern matching. As a result, all sites of the IC design containing DOI or DOI signatures stored in the defect signature library 140 are identified.

The defect signatures that have matches in the defect signature library 140 are classified and grouped by the signature grouping classification module 630. The grouping and the classification define the areas of the IC design that should be closely inspected or monitored in IC manufacturing. The signature grouping classification module 630 outputs these as IC manufacturing process setting parameters, which helps users to develop inspection/metrology recipes in IC manufacturing.

In another aspect, the intelligent learning engine 120 can store the manufacturing process setting parameters output by the comparison/classification module 150 and provide them as feedback to the global signature analysis grouping module 112. The global signature analysis/grouping module 112 can identify areas in the IC design with potential defect signatures using the manufacturing process setting parameters.

It should be understood that the disclosed systems and methods are not limited to the specific examples described above. For example, defect signatures can be represented by many different geometric shapes and metrics in real or frequency spaces.

What is claimed is:

1. An integrated-circuit yield improvement system, comprising:
a defect signature library that stores defect signatures; and
one or more computer processors comprising:
a global signature analysis/grouping module configured to receive an integrated circuit (IC) design and identify areas in the IC design that include potential defect signatures based on the defect signatures stored in the defect signature library, wherein the global signature analysis/grouping module is configured to produce a global signature map indicating these areas and their associated potential defect signatures in the IC design;
a local signature analysis/grouping module configured to receive the IC design, wherein the local signature analysis and grouping module is configured to identify and group local defect signatures in the IC design using the process monitoring and yield data as input, to output grouped local signatures; and
an intelligent learning engine configured to analyze the global signature map and the grouped local signatures for each location, and to store, in the defect signature library, some of the defect signatures in the global signature map and the grouped local signatures, wherein the integrated-circuit yield improvement system is configured to output parameters for setting IC manufacturing process based on the global signature map and the grouped local signatures.

2. The IC yield improvement system of claim 1, further comprising:
a filter and risk ranking module configured to identify killer defect signatures and filter out nuisance defects from the grouped local signatures and configured to output defects of interest comprising the killer defects.

3. The IC yield improvement system of claim 2, wherein the intelligent learning module is configured to produce rules for filtering defect signatures, wherein the filter and risk ranking module configured to filter out defects from the grouped local signatures based on the rules.

4. The IC yield improvement system of claim 1, further comprising a comparison and classification module configured to compare the defect of interests with the defect signatures in the defect signature library and to group defects of interests that have matched counterparts in the defect signature library, wherein the parameters for setting IC manufacturing process include the group defect of interests that have matched counterparts in the defect signature library.

5. The IC yield improvement system of claim 4, wherein the comparison and classification module comprises:
a signature search module configured to search the global signature map and the DOI for defect signatures as represented in the defects of interests;
a defect signature comparison engine configured to compare the defect signatures similar to DOI found in the search in the global signature map with the defect signatures stored in the defect signature library; and
a signature grouping classification module configured to group defects of interests that have matched counterparts in the defect signature library.

6. The IC yield improvement system of claim 4, wherein the intelligent learning engine is configured to store the manufacturing process setting parameters and to send the manufacturing process setting parameters as feedback to the global signature analysis grouping module, wherein the global signature analysis/grouping module is configured to identify areas in the IC design that include potential defect signatures using the manufacturing process setting parameters.

7. The IC yield improvement system of claim 1, wherein the global signature analysis/grouping module includes:
a partition and signature selection module configured to partition the IC design into functional blocks and to select a portion or all the IC design as defined by a user;
a global signature analysis module configured to detect potential defect signatures in the whole IC design based on the defect signatures stored in the defect signature library and to identify their respective positions in the IC design; and
a signature grouping module configured to group the defect signatures obtained by the global signature analysis module to produce the global signature map.

8. The IC yield improvement system of claim 1, wherein the local signature analysis/grouping module comprises:
a defect pattern selection configured to allow a user to select a local patterns in the IC design and the process and yield monitoring data;
a local signature analysis and sorting module configured to detect defect signatures in local areas of the IC design with the assistance of the defect signature library; and
a signature grouping module configured to separate the defect signatures in local areas obtained by the local signature analysis and sorting module into different groups to output the grouped local signatures.

9. An integrated-circuit yield improvement system, comprising:
a defect signature library that stores defect signatures; and
one or more computer processors comprising:
a global signature analysis/grouping module configured to receive an integrated circuit (IC) design and identify areas in the IC design that include potential defect signatures based on the defect signatures stored in the defect signature library, wherein the global signature analysis/grouping module is configured to produce a global signature map indicating these areas and their associated potential defect signatures in the IC design;
a local signature analysis/grouping module configured to receive the IC design, wherein the local signature analysis and grouping module is configured to identify and group local defect signatures in the IC design using the process monitoring and yield data as input, to output grouped local signatures;
a filter and risk ranking module configured to identify killer defect signatures and filter out nuisance defects from the grouped local signatures and configured to output defects of interest comprising the killer defects; and
an intelligent learning engine configured to analyze the global signature map and the grouped local signatures for each location, and to store, in the defect signature library, some of the defect signatures in the global signature map and the grouped local signatures, wherein the integrated-circuit yield improvement system is configured to output parameters for setting IC manufacturing process based on the global signature map and the grouped local signatures, wherein the intelligent learning module is configured to produce rules for filtering defect signatures, wherein the filter and risk ranking module configured to filter out defects from the grouped local signatures based on the rules.

10. The IC yield improvement system of claim 9, wherein the intelligent learning engine is configured to store the manufacturing process setting parameters and to send the manufacturing process setting parameters as feedback to the global signature analysis grouping module, wherein the global signature analysis/grouping module is configured to identify areas in the IC design that include potential defect signatures using the manufacturing process setting parameters.

11. The IC yield improvement system of claim 9, further comprising a comparison and classification module configured to compare the defect of interests with the defect signatures in the defect signature library and to group defects of interests that have matched counterparts in the defect signature library, wherein the parameters for setting IC manufacturing process include the group defect of interests that have matched counterparts in the defect signature library.

12. The IC yield improvement system of claim 11, wherein the comparison and classification module comprises:
a signature search module configured to search the global signature map and the DOI for defect signatures as represented in the defects of interests;
a defect signature comparison engine configured to compare the defect signatures similar to DOI found in the search in the global signature map with the defect signatures stored in the defect signature library; and
a signature grouping classification module configured to group defects of interests that have matched counterparts in the defect signature library.

13. The IC yield improvement system of claim 9, wherein the global signature analysis/grouping module includes:
a partition and signature selection module configured to partition the IC design into functional blocks and to select a portion or all the IC design as defined by a user;
a global signature analysis module configured to detect potential defect signatures in the whole IC design based on the defect signatures stored in the defect signature library and to identify their respective positions in the IC design; and
a signature grouping module configured to group the defect signatures obtained by the global signature analysis module to produce the global signature map.

14. The IC yield improvement system of claim 9, wherein the local signature analysis/grouping module comprises:
a defect pattern selection configured to allow a user to select a local patterns in the IC design and the process and yield monitoring data;
a local signature analysis and sorting module configured to detect defect signatures in local areas of the IC design with the assistance of the defect signature library; and
a signature grouping module configured to separate the defect signatures in local areas obtained by the local signature analysis and sorting module into different groups to output the grouped local signatures.

15. A computer-implemented method for improving manufacturing yield in an integrated circuit, comprising:
receiving an integrated circuit (IC) design in one or more computer processors that include a global signature analysis/grouping module, a local signature analysis/grouping module, and an intelligent learning engine, wherein the one or more computer processors are in communication with a defect signature library;
identifying, by a global signature analysis/grouping module, areas in the IC design that include potential defect signatures based on the defect signatures stored in the defect signature library;
producing, by the global signature analysis/grouping module, a global signature map indicating these areas and their associated potential defect signatures in the IC design;
identifying and grouping, by the local signature analysis and grouping module, local defect signatures in the IC design with the process monitoring and yield data as input, to output grouped local signatures;
analyzing the global signature map and the grouped local signatures for each location by the intelligent learning engine;
storing, in the defect signature library, by the an intelligent learning engine, some of the defect signatures in the global signature map and the grouped local signatures; and
outputting parameters for setting IC manufacturing process based on the global signature map and the grouped local signatures.

16. The computer-implemented method of claim 15, further comprising:
storing the manufacturing process setting parameters by the intelligent learning engine; and
sending the manufacturing process setting parameters from the intelligent learning engine to the global signature analysis grouping module, wherein the global signature analysis/grouping module is configured to identify areas in the IC design that include potential defect signatures using the manufacturing process setting parameters.

17. The computer-implemented method of claim 15, further comprising:
identifying killer defect signatures by a filter and risk ranking module;
filtering out nuisance defects by the filter and risk ranking module from the grouped local signatures; and
outputting defects of interest comprising the killer defects by the filter and risk ranking module.

18. The computer-implemented method of claim 15, further comprising:
producing rules for filtering defect signatures by the intelligent learning module; and
filtering out defects from the grouped local signatures based on the rules by the filter and risk ranking module.

19. The computer-implemented method of claim 15, further comprising:
comparing the defect of interests with the defect signatures in the defect signature library by a comparison and classification module; and
grouping defects of interests that have matched counterparts in the defect signature library by the comparison and classification module, wherein the parameters for setting IC manufacturing process include the group defect of interests that have matched counterparts in the defect signature library.

20. The computer-implemented method of claim 19, wherein the comparison and classification module is configured to search the global signature map and the DOI for defect signatures as represented in the defects of interests; compare the defect signatures similar to DOI found in the search in the global signature map with the defect signatures stored in the defect signature library; and group defects of interests that have matched counterparts in the defect signature library.

21. The computer-implemented method of claim 19, wherein the global signature analysis/grouping module is configured to partition the IC design into functional blocks and to select a portion or all the IC design as defined by a user, detect potential defect signatures in the whole IC design based on the defect signatures stored in the defect signature library and to identify their respective positions in the IC design, and to group the defect signatures obtained by the global signature analysis module to produce the global signature map.

22. The IC yield improvement system of claim 19, wherein the local signature analysis/grouping module is configured to allow a user to select a local patterns in the IC design and the process and yield monitoring data, to detect defect signatures in local areas of the IC design with the assistance of the defect signature library, and to separate the defect signatures in local areas obtained by the local signature analysis and sorting module into different groups to output the grouped local signatures.
